(19) United States
(12) Patent Application Publication
(10) Pub. No.: US 2019/0012822 A1
(43) Pub. Date: Jan. 10, 2019

(54) VIRTUAL REALITY SYSTEM WITH ADVANCED LOW-COMPLEXITY USER INTERACTIVITY AND PERSONALIZATION THROUGH CLOUD-BASED DATA-MINING AND MACHINE LEARNING

(71) Applicant: Cinova Media, Mountain View, CA (US)

(72) Inventor: Pierre Seigneurbieux, Mountain View, CA (US)

(21) Appl. No.: 16/027,966

(22) Filed: Jul. 5, 2018

Related U.S. Application Data
(60) Provisional application No. 62/528,908, filed on Jul. 5, 2017.

(51) Int. Cl. G06T 15/00; G06F 3/01; G06F 15/18; G06F 17/30

(52) U.S. Cl. CPC G06T 15/005; G06F 3/011; G06F 15/18; G06F 17/30979; G06F 17/30997; G06F 17/30991; G06F 17/3012

(57) ABSTRACT

A method and apparatus for real-time personalization and interactivity for a virtual reality data system uses back-end data mining and machine learning to generate meta-data that may be used by a player to provide interactivity to the user.

### PRIORITY CLAIMS/RELATED APPLICATIONS

This application claims the benefit under 35 USC 119(e) to U.S. Provisional Patent Application Ser. No. 62/528,908, filed Jul. 5, 2017 and entitled “Virtual Reality System With Advanced Low-Complexity User Interactivity And Personalization Through Cloud-Based Data-Mining And Machine Learning”, the entirety of which is incorporated herein by reference.

### FIELD

The field relates generally to video processing and in particular virtual reality video processing for interactivity and personalization.

### BACKGROUND

Virtual reality (VR) systems that provide virtual reality to a user using a head mounted display are ubiquitous. Virtual reality brings the potential of achieving true personalized and immersive experiences when watching a streamed video on demand (VOD) or live virtual reality asset. One of the key personalizations for virtual reality is for the user to be able to interact with the virtual reality content and being able to modify the original content based on personal characteristics of the user who is watching the content.

VR infrastructures built today gather analytics from their users, with the intent to be able to re-use these analytics over time to personalize the content based on viewing habits per geo-location, per content heat-maps, to name a few example. However, there is no framework built today to react in real-time and perform a true personalized VR experience in real time which is a technical problem with existing VR infrastructures. Thus, it is desirable to be able to true personalized VR experience in real time and it is to this end that the disclosure is directed.

### BRIEF DESCRIPTION OF THE DRAWINGS

FIG. 1 illustrates an example of a streaming virtual reality system that may incorporate an interactive and personalization architecture;

FIG. 2 illustrates an example of virtual reality data and a field of view;

FIG. 3 illustrates more details of the virtual reality data backend that is part of the system in FIG. 1; and

FIG. 4 illustrates an example of a method for data mining that may be used by the system in FIG. 1.

### DETAILED DESCRIPTION OF ONE OR MORE EMBODIMENTS

The disclosure is particularly applicable to a streaming virtual reality system that may use a field of view (FOV) based client/server type architecture that provides real-time interactivity and it is in this context that the disclosure will be described. It will be appreciated, however, that the below described architecture has greater utility since it may be used with other streaming virtual reality systems that may utilize a different architecture (peer to peer, single computer, mainframe computer, etc.), may be used with non-streaming video reality architecture and also may be used with other systems in which it is desirable to be able to provide real-time personalization and user interactivity. The personalization and interactivity architecture may separate the complexity of cloud-based asset's meta-data extraction from low-power mobile-based headsets, thus enabling advanced interactivity and personalized streaming experience on the consumer side as described below.

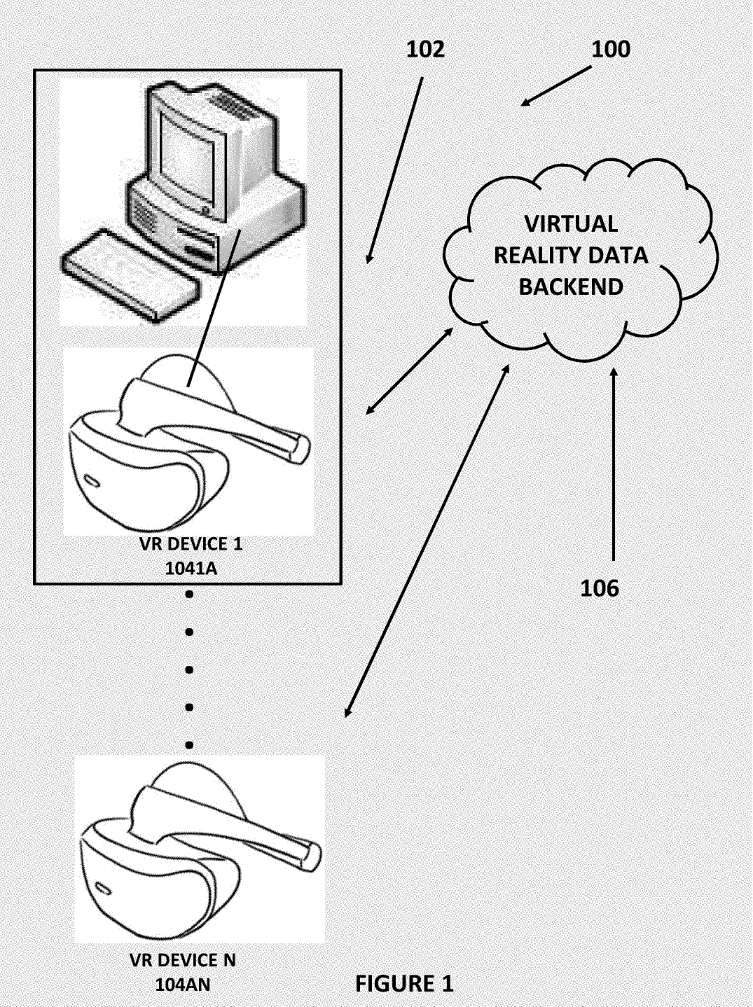

FIG. 1 illustrates a streaming virtual reality system 100 having a plurality of virtual reality devices 102 and a virtual reality data backend 106 that are coupled together by a communication path that the system 100 may utilize a personalization and interactivity architecture. The communication path between each virtual reality device 102 and the backend 106 may be a wired or wireless network, a cellular data network, a wireless computer data network, an Ethernet or optical data connection and the like. The communications path between each virtual reality device 102 and the backend 106 may be different (or have different components) and thus the communications path between each virtual reality device 102 and the backend 106 may each have different network latency.

In a streaming system as shown in FIG. 1, the backend 106 may receive data from each virtual reality device (including positioning/orientation data for the virtual reality device and/or network congestion data) and may perform the personalization and interactivity for virtual reality as described below. It is noted that the personalization and interactivity for virtual reality disclosed below also may be implemented in other virtual reality systems (that for example may not stream the virtual reality data but graphic rendering commands for example) and the streaming virtual reality system shown in FIG. 1 is just illustrative since the system and method may be used with any system in which it would be desirable to provide personalization and interactivity for virtual reality.

Each virtual reality device 102 may be a device that is capable of receiving virtual reality streaming data, processing the virtual reality streaming data (including possibly performing personalization and interactivity actions in some implementations as described below) and displaying the virtual reality streaming data to a user using some type of virtual reality viewing device. Each virtual reality device may further directly deliver an immersive visual experience to the eyes of the user based on positional sensors of the virtual reality device that detects the position of the virtual reality device and affects the virtual reality data being displayed to the user. Each virtual reality device 102 may include at least a processor, memory, one or more sensors for detecting and generating data about a current position/orientation of the virtual reality device 102, such as an accelerometer, etc., and a display for displaying the virtual reality streaming data. For example, each virtual reality device 102 may be a virtual reality headset, a computer having an attached virtual reality headset, a mobile phone with virtual reality viewing accessory or any other plain display device capable of displaying video or images. For example, each virtual reality device 102 may be a computing device, such as a smartphone, personal computer, laptop computer, tablet computer, etc. that has an attached virtual reality headset 104A1, or may be a self-contained virtual reality headset 104AN. Each virtual reality device 102 may have a player (that may be an application with a plurality of lines of computer code/instructions executed by a processor of the virtual reality device) that may process the virtual reality data and play the virtual reality data.

The system 100 may further comprise the backend 106 that may be implemented using computing resources, such as a server computer, a computer system, a processor, memory, a blade server, a database server, an application server and/or various cloud computing resources. The backend 106 may be implemented using a plurality of lines of computer code/instructions that may be stored in a memory of the computing resource and executed by a processor of the computing resource so that the computer system with the processor and memory is configured to perform the functions and operations of the system as described below. The backend 106 may also be implemented as a piece of hardware that has processing capabilities within the piece of hardware that perform the backend virtual reality data functions and operations described below. Generally, the backend 106 may receive a request for streamed virtual reality data for a virtual reality device (that may contain data about the virtual reality device) and perform the technical task of virtual reality data preparation (using one or more rules or lines of instructions/computer code). The VR data preparation may include generating the stream of known in view and out of view virtual reality data as well as the one or more pieces of personalized and interactive data for each virtual reality device based on each request for streamed virtual reality data for each virtual reality device 102. The backend 106 may then stream that streamed virtual reality data to each virtual reality device 102 that requested the virtual reality data. The streamed virtual reality data with the personalization and interactivity solves the technical problems of providing real time interactivity that is lacking in current virtual reality systems.

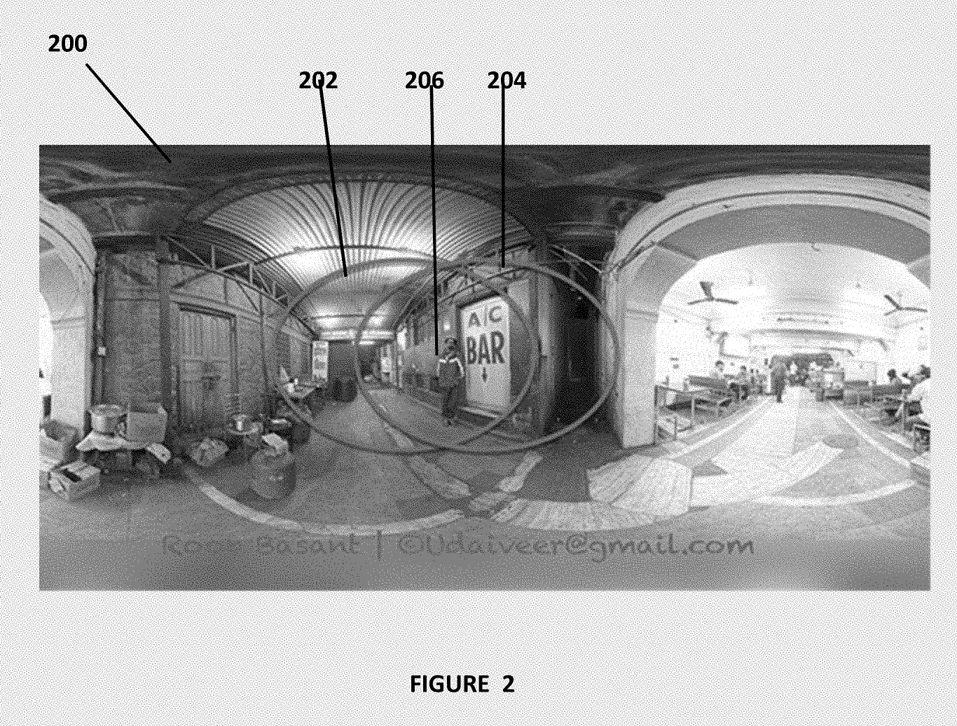

FIG. 2 illustrates an example of a frame of virtual reality data 200, a view of each eye of the virtual reality device 202, 204 and a viewpoint 206 (also known as an “in-view portion” or “field of view”). In a typical virtual reality streaming system, the virtual reality data may be a plurality of frames of virtual reality data that may be compressed using various compression processes such as MPEG or H.264 or H.265. For purposes of illustration, only a single frame is shown in FIG. 2, although it is understood that the processes described below may be performed on each frame of virtual reality streaming data. In a virtual reality streaming data system, a viewer/user typically views this frame of virtual data (that is part of the virtual reality data video or virtual reality streamed data (collectively the “asset”) using the virtual reality device 102 that plays back only a section of the whole frame/video based on the direction in which the virtual reality device 102 is positioned by the user who is wearing the device that may be determined by the sensors/elements of the device 102. As shown in FIG. 2, based on the direction/position of the virtual reality device, a certain portion of the frame, such as a left eye view portion 202 and a right eye portion 204 may be within the view of the user of the virtual reality device 102. For example, the virtual reality device may provide a viewport that has the left eye view portion 202, the right eye view portion 204 as shown by the overlapping ovals shown in FIG. 2 and a central region 206 (the field of view) that is displayed to both eyes of the user similar to how a human being's eyes operate so that the virtual reality system provides an immersive experience for the user. Depending upon the configuration of the virtual reality device, the field of view of the virtual reality device determines the specific portion of the frame that needs to be displayed to each eye of the user. As an example, a virtual reality device with a 90-degree horizontal and vertical field of view, will only display about ¼^{th} of the frame in the horizontal direction and ½ of the frame in the vertical direction.

The personalization and interactivity system and method may include three elements/engines to build a best-in-class interactivity and personalization while keeping minimal processing on the end-user side through cloud-based data mining and machine learning during ingest and distribution of the video content. The system may include several features in the backend 106 as well as features in each player of each virtual reality device 102.

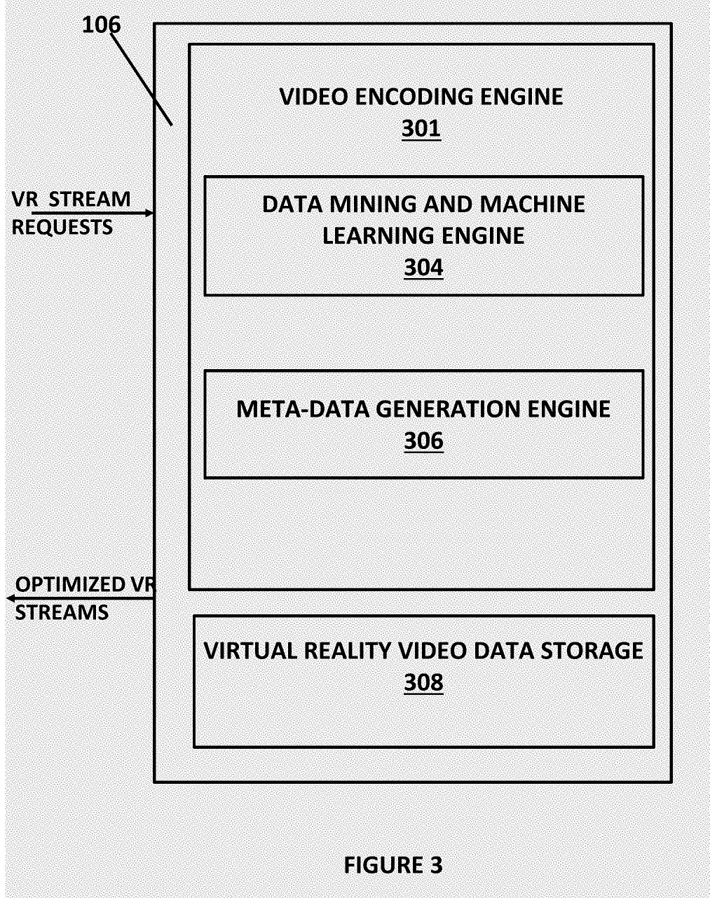

FIG. 3 illustrates more details of the virtual reality data backend 106 that is part of the system in FIG. 1 that provides the personalization and interactivity in real time. In one implementation, the virtual reality data backend 106 may be cloud based and may be implemented using various known cloud computing resources including processor(s), memory, servers, etc. hosted in the cloud such as Amazon AWS components. The virtual reality data backend 106 may receive a virtual reality stream request from each virtual reality device 102 of the system (wherein each virtual reality stream request may be different from each virtual reality device 102 may be viewing the same or a different piece of virtual reality data (a different virtual reality data asset) and each virtual reality device 102 may have a particular field of view that may be the same or different from the other virtual reality devices 102) and then generate an optimized virtual reality stream (including the personalization and interactivity meta-data) for each virtual reality device 102. In one implementation, the system may be a FOV based virtual reality system that is capable of handling a plurality of virtual reality data requests and may be scaled as needed by employing additional cloud computing resources.

The virtual reality data backend 106 may include a video encoding engine 301 and a virtual reality video data storage 308. The video encoding engine 301 may be implemented in hardware, software or a specially designed piece of hardware that performs the video encoding as described below. When the video encoding engine 301 is implemented in software, it may have a plurality of lines of computer code/instructions that may be executed by one or more processors of a computer system (that may also have a memory and other elements of computer system) so that the processor(s) or computer system are configured to perform the operations of the video encoding engine as described below. When the video encoding engine 301 is implemented in hardware, it may be a hardware device, ASIC, integrated circuit, DSP, micro-controller, etc. that can perform the operations of the video encoding engine as described below. The virtual reality video data storage 308 may be hardware or software based storage.

The video encoding engine 301 may perform various virtual reality data processing processes in response to each virtual reality data request from each virtual reality data device 102. For example, the video encoding engine 301 may perform a data mining and learning process, a interactivity meta-data generation process and also encode the optimized virtual reality data stream for each virtual reality device and its player as described below. The virtual reality video data storage 308 may store data used by the system in FIG. 1 including, for example, user data, the interactivity meta-data, the data mining data, data about the characteristics of each type of virtual reality device 102 that may request virtual reality data, field of view (FOV) data stored for a plurality of different pieces of virtual reality data content (an “asset”) and/or data for each virtual reality data asset that may be streamed using the system in FIG. 1.

The video encoding engine 301 may further comprise a data mining and machine learning engine 304 and a meta-data generating engine 306, each of which may be implemented in hardware or software. The data mining and machine learning engine 304 may perform the cloud-based data mining and machine learning during ingest and distribution of the video content and relieve each player of performing some of the personalization and interactivity processes to provide the real-time personalization and interactivity. The meta-data generating engine 306 may generate the interactivity meta-data as described below that may be then encoded into the optimized virtual reality data stream that is communicated to each player in each virtual reality device.

Cloud-Based Data Mining and Machine Learning

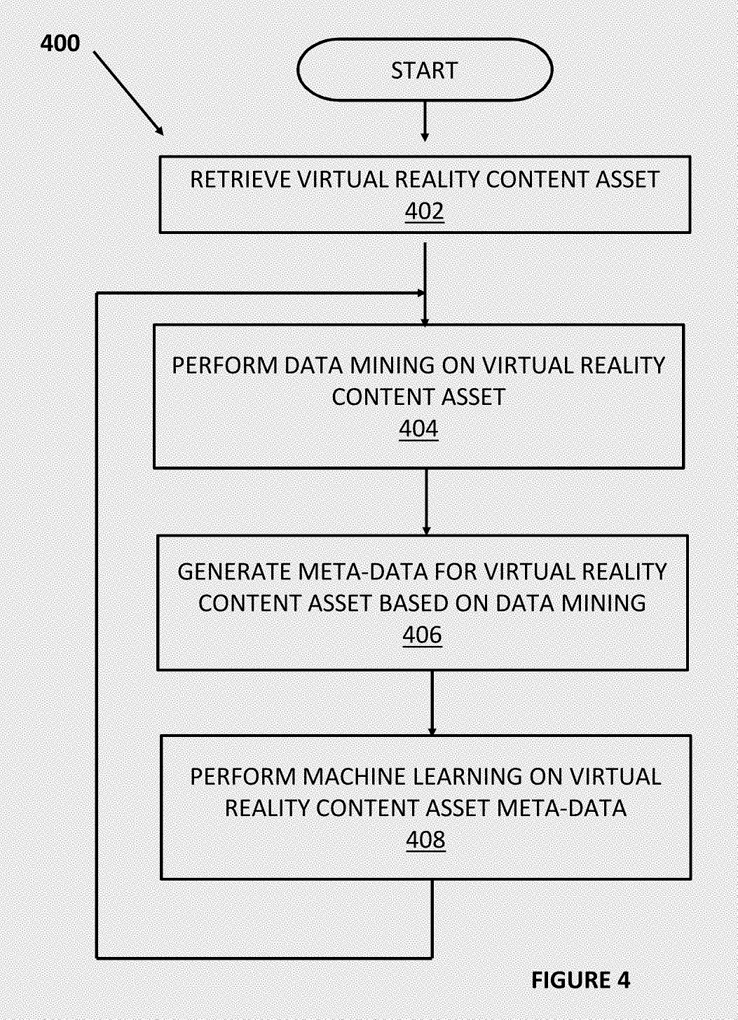

FIG. 4 illustrates an example of a method 400 for data mining that may be used by the system in FIG. 1. In one example, the method 400 may be performed using the data mining and machine learning engine 304. The method may retrieve each piece of virtual reality content asset (402) that may be retrieved from an external source or stored in the storage 308 as each piece of virtual reality content is being ingested into the backend 106. The method may then perform data mining on each virtual reality data content asset (404) using set of algorithms, such as pattern recognition, comparing against well-known sceneries, well-known content type (sport vs. movie) for example. The data mining and machine learning process perform CPU intensive processing on the original virtual reality content (stored in the storage 308 or retrieved from an external source) to extract various information. The information extracted from each piece of virtual reality content may include:
Nature of the content: sport vs. movie vs. talking heads
Set of frames classification: background vs foreground location, main elements detection: a car, an object, a brand etc. . . .
Location of score boards for a sport
Location of ad banners for a sport
Location of players in the field for a sport
Etc. . . .

The above information may be meta-data that is generated (406) as part of the method.

The method may, from time to time, perform a machine learning process (408) to improve the data mining process above and find similarities between meta-data of the same kind. A good example of machine learning is when tracking players on a field. While Jersey numbers might not be seeable on all frames, being able to locate some on specific scenes can help to derive the location of players at all time by inspecting the motion of each player. In the method, the process of data mining (the method looping back to the data mining process 404) may be re-run over time on all assets to keep improving the meta-data that is generated, for example, by the meta-data generating engine 306 shown in FIG. 3.

Streaming of Meta-Data to Each Player

When a player connects to the backend 106 for a user to watch a specific virtual reality data content asset, the optimized virtual reality data stream for the particular player may include the virtual reality video data and the generated stream of meta-data. The optimized virtual reality data stream may be different for each player since each virtual reality device (with the player) may be viewing a different piece of virtual reality data content asset or may be presented viewing a different field of view. The stream of meta-data may be used by the particular player to implement personalization. Because the player does not need to perform any metadata search or extraction, this allows for very low complexity processing on virtual reality devices, such as mobile phones for example.

As an example, on a frame by frame basis for the virtual reality data asset provided to the particular player, the player may receive (as part of the optimized virtual reality data) any kind of information that was collected, such as by the backend 106 in the cloud. For example, if the virtual reality data content asset for the particular player is a basketball game, the player may receive details on:
Video layout: field vs. ad banners, vs score board vs. spectators
Location of players on the field
Jersey numbers helping retrieving the player names

Depending of the level of interactivity and/or personalization required by the user and the layer, not all metadata may be sent at all time. In fact, only meta-data information that is needed by the player may be sent based on the player context as discussed below. Thus, the player may only receive a small subset of the original metadata collected/generated which is the metadata that the player can actually use based on the current player needs. Due to the meta-data being sent to the player, the player can implement very advanced interactivity with zero processing on the incoming content itself since that processing in completed at the backend 106.

Player: User Interactivity and Personalization

Each player may rely on the metadata coming from the backend 106 to provide personalization and/or interactivity for a specific scene in the virtual reality data content asset. However, the trigger from the interactivity does not need to come from the backend 106 and may be separated. For example, the player can determine the following information without the backend 106 that may be used as a trigger:
Device geo-location
User profile
Facebook and/or tweeter account
Viewing Heat-map

As an example, if the user is currently watching a basketball game, and has expressed a desire to see advanced statistics from the players, the player may implement the following:
Enable statistics gathering from the internet (not from the backend cloud 106)
For the team mapping, use user profile (aka which team the player is likely to cheer for)
The interactivity based on the user's favorite team may be provided even though the player is not watching from his home town
Using the current view point, the player can determine if the user has specific jersey numbers in his FOV (by comparing with the metadata received from the backend 106)→resulting in a low complexity search on the player side
Eye tracking could be used to even locate the specific player the user is looking at
Once the set of players or unique player is detected, the player can easily overlay stats gathered from the internet onto the video being streamed

Following the same idea, ad banners can be replaced with ads that map the user profile better. Furthermore, score boards can also be modified to reflect better what the user is interested in seeing based on his profile, and/or app settings.

The foregoing description, for purpose of explanation, has been described with reference to specific embodiments. However, the illustrative discussions above are not intended to be exhaustive or to limit the disclosure to the precise forms disclosed. Many modifications and variations are possible in view of the above teachings. The embodiments were chosen and described in order to best explain the principles of the disclosure and its practical applications, to thereby enable others skilled in the art to best utilize the disclosure and various embodiments with various modifications as are suited to the particular use contemplated.

The system and method disclosed herein may be implemented via one or more components, systems, servers, appliances, other subcomponents, or distributed between such elements. When implemented as a system, such systems may include and/or involve, inter alia, components such as software modules, general-purpose CPU, RAM, etc. found in general-purpose computers. In implementations where the innovations reside on a server, such a server may include or involve components such as CPU, RAM, etc., such as those found in general-purpose computers.

Additionally, the system and method herein may be achieved via implementations with disparate or entirely different software, hardware and/or firmware components, beyond that set forth above. With regard to such other components (e.g., software, processing components, etc.) and/or computer-readable media associated with or embodying the present inventions, for example, aspects of the innovations herein may be implemented consistent with numerous general purpose or special purpose computing systems or configurations. Various exemplary computing systems, environments, and/or configurations that may be suitable for use with the innovations herein may include, but are not limited to: software or other components within or embodied on personal computers, servers or server computing devices such as routing/connectivity components, hand-held or laptop devices, multiprocessor systems, microprocessor-based systems, set top boxes, consumer electronic devices, network PCs, other existing computer platforms, distributed computing environments that include one or more of the above systems or devices, etc.

In some instances, aspects of the system and method may be achieved via or performed by logic and/or logic instructions including program modules, executed in association with such components or circuitry, for example. In general, program modules may include routines, programs, objects, components, data structures, etc. that perform particular tasks or implement particular instructions herein. The inventions may also be practiced in the context of distributed software, computer, or circuit settings where circuitry is connected via communication buses, circuitry or links. In distributed settings, control/instructions may occur from both local and remote computer storage media including memory storage devices.

The software, circuitry and components herein may also include and/or utilize one or more type of computer readable media. Computer readable media can be any available media that is resident on, associable with, or can be accessed by such circuits and/or computing components. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic tape, magnetic disk storage or other magnetic storage devices, or any other medium which can be used to store the desired information and can accessed by computing component. Communication media may comprise computer readable instructions, data structures, program modules and/or other components. Further, communication media may include wired media such as a wired network or direct-wired connection; however no media of any such type herein includes transitory media. Combinations of the any of the above are also included within the scope of computer readable media.

In the present description, the terms component, module, device, etc. may refer to any type of logical or functional software elements, circuits, blocks and/or processes that may be implemented in a variety of ways. For example, the functions of various circuits and/or blocks can be combined with one another into any other number of modules. Each module may even be implemented as a software program stored on a tangible memory (e.g., random access memory, read only memory, CD-ROM memory, hard disk drive, etc.) to be read by a central processing unit to implement the functions of the innovations herein. Or, the modules can comprise programming instructions transmitted to a general purpose computer or to processing/graphics hardware via a transmission carrier wave. Also, the modules can be implemented as hardware logic circuitry implementing the functions encompassed by the innovations herein. Finally, the modules can be implemented using special purpose instructions (SIMD instructions), field programmable logic arrays or any mix thereof which provides the desired level performance and cost.

As disclosed herein, features consistent with the disclosure may be implemented via computer-hardware, software and/or firmware. For example, the systems and methods disclosed herein may be embodied in various forms including, for example, a data processor, such as a computer that also includes a database, digital electronic circuitry, firmware, software, or in combinations of them. Further, while some of the disclosed implementations describe specific hardware components, systems and methods consistent with the innovations herein may be implemented with any combination of hardware, software and/or firmware. Moreover, the above-noted features and other aspects and principles of the innovations herein may be implemented in various environments. Such environments and related applications may be specially constructed for performing the various routines, processes and/or operations according to the invention or they may include a general-purpose computer or computing platform selectively activated or reconfigured by code to provide the necessary functionality. The processes disclosed herein are not inherently related to any particular computer, network, architecture, environment, or other apparatus, and may be implemented by a suitable combination of hardware, software, and/or firmware. For example, various general-purpose machines may be used with programs written in accordance with teachings of the invention, or it may be more convenient to construct a specialized apparatus or system to perform the required methods and techniques.

Aspects of the method and system described herein, such as the logic, may also be implemented as functionality programmed into any of a variety of circuitry, including programmable logic devices (“PLDs”), such as field programmable gate arrays (“FPGAs”), programmable array logic (“PAL”) devices, electrically programmable logic and memory devices and standard cell-based devices, as well as application specific integrated circuits. Some other possibilities for implementing aspects include: memory devices, micro-controllers with memory (such as EEPROM), embedded microprocessors, firmware, software, etc. Furthermore, aspects may be embodied in microprocessors having software-based circuit emulation, discrete logic (sequential and combinatorial), custom devices, fuzzy (neural) logic, quantum devices, and hybrids of any of the above device types. The underlying device technologies may be provided in a variety of component types, e.g., metal-oxide semiconductor field-effect transistor (“MOSFET”) technologies like complementary metal-oxide semiconductor (“CMOS”), bipolar technologies like emitter-coupled logic (“ECL”), polymer technologies (e.g., silicon-conjugated polymer and metal-conjugated polymer-metal structures), mixed analog and digital, and so on.

It should also be noted that the various logic and/or functions disclosed herein may be enabled using any number of combinations of hardware, firmware, and/or as data and/or instructions embodied in various machine-readable or computer-readable media, in terms of their behavioral, register transfer, logic component, and/or other characteristics. Computer-readable media in which such formatted data and/or instructions may be embodied include, but are not limited to, non-volatile storage media in various forms (e.g., optical, magnetic or semiconductor storage media) though again does not include transitory media. Unless the context clearly requires otherwise, throughout the description, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

Although certain presently preferred implementations of the invention have been specifically described herein, it will be apparent to those skilled in the art to which the invention pertains that variations and modifications of the various implementations shown and described herein may be made without departing from the spirit and scope of the invention. Accordingly, it is intended that the invention be limited only to the extent required by the applicable rules of law.

While the foregoing has been with reference to a particular embodiment of the disclosure, it will be appreciated by those skilled in the art that changes in this embodiment may be made without departing from the principles and spirit of the disclosure, the scope of which is defined by the appended claims.

1. A virtual reality data system, comprising:
a virtual reality data backend;
a plurality of virtual reality devices coupled to the virtual reality data backend, each virtual reality device having a head mounted display and a player;
the virtual reality data backend having a data mining engine that retrieves a piece of virtual reality data content and processes the piece of virtual reality data content to generate interactivity meta-data for the piece of virtual reality data content and a video encoding engine that generates optimized virtual reality data that includes the virtual reality data content and the generated meta-data; and
the player in each virtual reality device receiving the optimized virtual reality data from the virtual reality data backend and generating interactivity when the virtual reality data is being displayed in the head mounted display.

2. The system of claim 1, wherein the data mining engine further comprises a machine learning element that performs machine learning to improve the generated meta-data.

3. The system of claim 1, wherein the backend further comprises a storage that stores the meta-data generated for each piece of virtual reality data.

4. The system of claim 3, wherein the storage stores the optimized virtual reality data from the piece of virtual reality content.

5. The system of claim 1, wherein the player generates a trigger that initiates the interactivity based on the received meta-data received from the backend.

6. A method comprising:
retrieving a piece of virtual reality data asset in a virtual reality data backend;
performing data mining on the virtual reality data asset to generate information about each scene of the virtual reality data asset;
generating meta-data for each scene of the virtual reality data asset; and
communicating optimized virtual reality data to a player in a virtual reality device, the optimized virtual reality data having the virtual reality data for the virtual reality data asset and the generated meta-data for each scene of the virtual reality data.

7. The method of claim 6 further comprising providing, by the player in the virtual reality device, interactive data to the user using the generated meta-data for each scene of the virtual reality data.

8. The method of claim 6 further comprising performing machine learning to improve the generated meta-data for each scene of the virtual reality data.

9. The method of claim 6, wherein retrieving the piece of virtual reality data asset further comprises retrieving the piece of virtual reality data asset from one of an external source and a storage of the virtual reality data backend.

10. The method of claim 7 further comprising generating, in the player, a trigger that initiates the interactivity based on the received meta-data received from the backend.

11. An apparatus, comprising:
a virtual reality device having a head mounted display and a low complexity computer system connected to the head mounted display, the computer system having a virtual reality data player executed by a processor of the low complexity computer system that is configured to:
receive an optimized virtual reality data that includes the virtual reality data content and the generated meta-data, the generated meta-data generated by a virtual reality backend connected to the virtual reality device by retrieving a piece of virtual reality data content and processing the piece of virtual reality data content to generate interactivity meta-data for the piece of virtual reality data content; and
generate interactivity on the low complexity computer system when the virtual reality data is being displayed in the head mounted display based on the received meta-data.
